(19) United States
(12) Patent Application Publication
(10) Pub. No.: US 2025/0153126 A1
(43) Pub. Date: May 15, 2025

(54) FIXED BED GASIFIER

(71) Applicant: Sierra Energy Corporation, Davis, CA (US)

(72) Inventors: Johan Van Walsem, Davis, CA (US); Daniel Dodd, Davis, CA (US); Paul Vergnani, Davis, CA (US)

(21) Appl. No.: 18/840,841

(22) PCT Filed: Feb. 23, 2023
(86) PCT No.: PCT/US2023/013741

§ 371 Date: Aug. 22, 2024

Related U.S. Application Data
(60) Provisional application No. 63/313,796, filed on Feb. 25, 2022.

(51) Int. Cl. B01J 8/02; C01B 3/02; C01B 3/50; C10J 3/24

(52) U.S. Cl. CPC B01J 8/0278; B01J 8/0285; C01B 3/02; C01B 3/50; C10J 3/24; B01J 2208/00176; B01J 2208/00504; B01J 2208/00884; C01B 2203/048; C01B 2203/0811; C10J 2300/0946

(57) ABSTRACT

Provided herein is a gasifier, preferably a fixed bed, slagging, updraft oxygen gasification reactor or gasifier with features to facilitate gasification of heterogeneous waste streams producing a syngas with minimal level of condensable tars whilst simultaneously removing molten slag from the bottom of the bed via a cooled slag collector (“CSC”); syngas and other compositions produced therefrom; and processes including it.

### CROSS REFERENCE TO RELATED APPLICATIONS

This application claims the benefit of priority to U.S. Provisional Patent Application No. 63/313,796 filed Feb. 25, 2022, which is hereby incorporated by reference, in its entirety for any and all purposes.

### FIELD

The present technology relates to a gasification reactor or gasifier, preferably a fixed bed, slagging, updraft oxygen gasifier; compositions produced therefrom; and processes including it.

### BACKGROUND

Significant limitations have prevented the adoption of gasifiers for heterogeneous waste gasification beyond being used in blends with coal. Further, whereas ash resulting from clean wood gasifiers may be land-applied, this is not the case for heterogeneous waste or treated waste wood that is typically classified as hazardous waste. There remains a significant need for a gasifier that can be used for feedstocks other than coal such as biomass or plastic waste and other heterogeneous waste streams. Such gasifiers will not have a high parasitic electrical load and are not overly sensitive to feed material morphology, especially excessive fineness.

### SUMMARY

In one aspect provided herein is gasifier preferably for gasifying a heterogeneous waste. In one embodiment, the gasifier is a fixed bed gasifier. In another embodiment, the gasifier is an oxygen blown gasifier. In another embodiment, the gasifier is a slagging gasifier.

In another aspect, provided herein is a syngas composition also referred to simply as syngas, and other compositions. In one embodiment, the syngas composition is provided by gasifying a heterogeneous waste employing a gasifier provided herein.

In another aspect provided herein is a process of gasifying heterogeneous waste. In one embodiment, the process comprises gasifying the heterogeneous waste in a gasifier provided herein. In one composition embodiment, the slag produced by gasification of heterogeneous waste in a gasifier provided herein is non-leaching according to TCLP testing.

In one embodiment, the gasifier does not comprise a plasma torch. In another embodiment, the gasifier does not comprise a bed permeability additive. An illustrative example of abed permeability additive is narrow size distribution 50-100 mm lump coke.

The present invention is directed in part at a fixed bed, slagging, updraft oxygen gasification reactor with features to facilitate gasification of heterogeneous waste streams with a wide size range and high volatile matter typically associated with waste streams producing a syngas with minimal level of condensable tars exiting the gasification reactor whilst simultaneously allowing slag to drain freely from the bed through one of more slag holes into a molten slag reservoir where further conversion of any residual carbon occurs prior to slag being tapped and/or quenched using conventional methods.

In one embodiment, the gasifier is characterized as a vessel with vertical orientation with a number of distinct zones to accomplish the above objectives. In one embodiment, feed material is fed into the gasifier at an intermediate height using multiple feed ports to achieve an even distribution. Additional bed permeability materials or slag additives can also be fed from the top of the vessel via gravity if desired for optimal operation. The feed material flows downward through the bed and gasification reactions are supported by oxygen and steam that are injected through multiple lances (also referred to as tuyeres in the industry) distributed around the periphery at different heights to control the temperature profile through the bed for efficient gasification. Without being bound by theory, it is generally desired to maintain a relatively slow heating rate to the ultimate peak gasification temperature to allow for controlled pyrolysis in the upper sections to minimize tar generation and maximize secondary char or carbonaceous solid carbon formation that provides the substrate for the lower oxygen gasification reactions. The peak gasification temperature is achieved in the lower gasifier and the oxygen and steam ratio injected through the lances are controlled to achieve an operating temperature of at least about 1250° C. and preferably greater than about 1500° C. to ensure full conversion of solid carbonaceous material and effective melting of the mineral and ash content of the feedstock (“slagging”). The arrangements of the lances can be varied in terms of: spacing around the periphery, location relative to bed height, downward angle and offset angle from the normal line (i.e. a line that is perpendicular to the tangent of the reactor vessel wall at the lance location) to create the optimal temperature profile and ensure consistent movement of the bed across the diameter of the gasifier.

In one embodiment, the gasifier is further characterized by having an actively cooled bed support structure (referred to as the cooled slag collector or “CSC”) positioned above the molten slag reservoir. The CSC supports the bed above, collects molten slag, and directs the slag to one or multiple slag holes to allow free drainage under gravity into the slag reservoir. The CSC is actively cooled to ensure formation of a protective skull according to design principles known by those skilled in the art. See, Nelson, L. R. and Hundermark, R. J. (2016) The tap-hole—key to furnace performance, The Journal of the Southern African Institute of Mining and Metallurgy, volume 116, page no. 465-490, incorporated herein in its entirety by reference). A CSC with multiple slag holes around the periphery can promote redistribution of solid material flow from the center to the outer diameter of the gasifier and ensure material movement across the entire cross section of the gasifier. This allows gasification of more heterogeneous materials without requiring bed permeability additives and high level of coal or coke co-feed for stable operation.

In one embodiment, the slag is not tapped directly from the bottom of the bed but allowed to drain under gravity into a slag reservoir that has a slag liquid level and headspace above. Oxyfuel burners are provided in the headspace of the slag reservoir in a very analogous fashion to a glass melting furnace to ensure slag remains in the optimal temperature regime for tapping, typically in the range from about 1250° C. to about 1500° C. The temperature can be controlled via modulation of the burners to maintain the optimal viscosity for tapping and granulation without causing excessive corrosion or erosion of the refractory resulting from excessive slag temperature. Without being bound by theory, the combustion gases of the oxyfuel burners, CO₂ and H₂O above about 1500° C., maintain the desired slag temperature and also react with residual carbon or particles that may have dropped through the slag holes and will float freely on the slag surface given high specific gravity of molten slag. These endothermic gasification reactions of carbon with CO₂ and H₂O result in very high conversion of carbon into additional syngas CO and H₂ and results in a slag with minimal carbon content to ensure full vitrification of mineral matter and desirable properties for downstream market applications such as road base or cement additives. The combustion gases then flow upwards through the slag holes and an optional by-pass to provide additional supplemental heat into the lower gasification zone. This allows gasification of feedstock with high volatile content and high ash content that would otherwise not generate enough heat via oxygen reactions only to fully melt the ash. Notably, this allows for use of feedstock with volatile content of 45% or more, and thereby reduces or preferably eliminates the requirement for coal or coke in the feed, especially in a cost-effective manner without high parasitic electrical load, resulting e.g. from plasma torches. The oxyfuel burners can use any convenient gaseous or liquid fuel such as natural gas, landfill gas, propane, diesel, and most preferably recycled syngas or purge gas from downstream syngas purification unit operations to allow the gasifier to be operated without any exogenous fuel sources.

In one embodiment, the gasifier of the current invention is further characterized by having variable diameter and side walls that can be vertical or conical with angles selected to optimize the gas and solids flow in each zone as well as residence times. In one embodiment, employed herein is an upper zone above the side feed ports where additional oxygen and steam lances and/or burners are located to reheat the syngas that leaves the top of the bed typically below about 500° C. to greater than about 1000° C. and preferably greater than about 1,100° C. with a residence time of at least about 2 seconds and up to about 5 seconds. Through control of residence time, temperature as well as oxygen and steam it has been found that the high tar content characteristic of upflow gasifiers in the range of about 100 to about 200 g tar/Nm³ syngas can be effectively reduced to less than about 5 g tar/Nm³ and typically less than about 2 g tar/Nm³ and most preferably less than about 1 g tar/Nm³ (tar being defined as hydrocarbons heavier than C3 compounds). Prior to exiting the gasifier syngas is quenched to an intermediate temperature typically less than about 800° C. to avoid fouling from sticky ash components in downstream heat recovery and solids removal operations.

In one embodiment, the syngas exiting the gasifier enters a cyclone at nearly the same temperature as the upper zone, not below 900° C., to remove carbonaceous particulate at sufficient temperature to minimize condensation of alkali salts, examples of which are not limited to Na₂O, K₂O, NaCl, and KCl. This facilitates recovery and recycle of carbonaceous particulate into the gasifier.

These and other aspects of the invention can be applied for the general purpose of converting multiple different waste streams into syngas that can be converted into multiple end-products using known techniques by those skilled in the art. Without limiting the foregoing exemplary products include hydrogen, synthetic natural gas, methanol, ammonia, liquid fuels and, gaseous feedstock for microbial fermentation to produce feed protein, biodegradable polymers or alcohols. In another embodiment a CO₂ co-product with purity greater than about 95% and preferably greater than about 99.5% is recovered from purge or tail gas following conversion of syngas to products.

The following disclosure provides, inter alia, these and other aspects of the invention, and non-limiting examples of various embodiments of the invention.

### BRIEF DESCRIPTION OF DRAWINGS

FIG. 1 is a sectional elevation view, of one example of the gasifier in accordance with various embodiments.

FIG. 2 is a sectional elevation view of the cooled slag collector and slag reservoir below in accordance with various embodiments.

FIG. 3 is a sectional elevation view of the slag reservoir below with slag level control and continuous tapping that can be applied in various embodiments.

FIG. 4 is a sectional elevation view of the cooled slag collector with a taphole arrangement and quench nozzles below to collect granulated slag in a reservoir, in accordance with various embodiments.

FIG. 5 is a schematic showing the arrangement of gasifier lances along the periphery of the gasifier that can be applied in various embodiments.

FIG. 6 and FIG. 7 are partial and schematic views of the cooled slag collector (“CSC”) with multiple slag holes and a cutaway showing limpet coils to cool the plate and spiral cooling coils to cool the slag holes, that can be applied in various embodiments.

FIG. 8 is the temperature profile of the upper surface of the steel plate of the CSC for FIG. 6 and FIG. 7 modeled in Ansys CFD, according to various embodiments.

FIG. 9 is a plan view in section of the nozzle orientation in the polisher section of a gasifier, according to various embodiments.

FIG. 10 is a schematic output of the gas flow profiles from a CFD (computational fluid dynamics) analysis of the polisher section of a gasifier, according to various embodiments.

FIG. 11 is a graph with temperature and flowing slag film thickness modeled for a single slag hole 10 of the CSC depicted in FIG. 6.

FIG. 12 and FIG. 13 are pictures of physical example of the cooled slag collector of FIG. 6 before and after operation in representative gasifier, according to various embodiments.

FIG. 14 is a partial schematic view of a CSC with a single slag hole 10 designed to build a stable protective layer of cooled slag, according to various embodiments.

FIG. 15 and FIG. 16 are the temperature profiles modeled in ANSYS Fluent CFD for the design in FIG. 14 where material thermal properties and cooling geometry do not produce a stable protective layer of cooled slag, according to various embodiments.

FIG. 17 and FIG. 18 are the temperature profiles modeled in ANSYS Fluent CFD for the design in FIG. 14 with improved materials and cooling geometry to support the formation of a stable protective layer of cooled slag, according to various embodiments.

### DETAILED DESCRIPTION

### Definitions

In this specification and in the claims that follow, reference will be made to a number of terms that have the meanings below. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

In this specification and in the claims that follow, reference will be made to a number of terms that have the meanings below. All numerical designations, e.g., temperature, time, concentration, and weight, including ranges of each thereof, are approximations that typically may be varied (+) or (−) by increments of 0.1, 1.0, or 10.0, as appropriate. All numerical designations may be understood as preceded by the term “about”.

The singular form “a”, “an”, and “the” includes plural references unless the context clearly dictates otherwise. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Bed material refers to the solid material present in the gasifier above the cooled slag collector comprising fresh feed material at the top, partially devolatilized material in the next lower zone, and solid carbonaceous material, substantially devolatilized, and containing the residual ash in the lowest gasification zone.

The term “comprising” means any recited elements are necessarily included and other elements may optionally be included. “Consisting essentially of” means any recited elements are necessarily included, elements that would materially affect the basic and novel characteristics of the listed elements are excluded, and other elements may optionally be included. “Consisting of” means that all elements other than those listed are excluded. Embodiments defined by each of these terms are within the scope of this invention.

Gasification refers to gasifying coal, liquids, dust, slurries and includes waste gasification such as heterogeneous waste gasification. In lower temperature gasification (generally below about 1000° C.) dry ash is generated as a waste product. In higher temperature gasification, e.g., those performed by a slagging gasifier, operate at temperatures in excess of the ash melting point (generally above about 1400° C.) and produce a molten slag that is typically quenched. A gasifier or a gasification reactor performs gasification. Gasifiers include fixed bed, fluid bed, circulating fluid bed and entrained flow gasifiers.

Heterogeneous waste refers to without limitation municipal solid waste (“MSW”), wood, agricultural waste, shredded tires, coal, petcoke or hydrocarbon waste streams with variable particle morphology such as in a size range from 6 mm to 100 mm outside the range that can be handled by fluid bed, entrained flow or existing fixed bed gasification processes.

Synthesis gas (“syngas”) is the gaseous product of the gasification of heterogeneous waste which is comprised of CO, H₂, CO₂, H₂O, CH₄, C2 and higher hydrocarbons including condensable hydrocarbons heavier than C3 compounds (i.e. tar) and solids carried over with the syngas comprising carbonaceous soot and mineral ash components.

Lambda refers to the ratio of the amount of oxygen actually present in a combustion chamber compared to the amount that should have been present in order to obtain “perfect” combustion. Thus, when a mixture contains exactly the amount of oxygen required to burn the amount of fuel present, the ratio will be one to one and lambda will equal 1.00. If the mixture contains more oxygen for the amount of fuel (a lean mixture), lambda will be greater than 1.00. If a mixture contains less oxygen for the amount of fuel (a rich mixture), lambda will be less than 1.00.

Lance refers to a device that is inserted into the gasifier and secured via a suitable flange to the vessel with provision of one or multiple fluid passages that can be arranged as individual tubes or annular flow passages to inject one or more gasification agents or feedstocks including oxygen, steam, supplemental fuel gas, CO₂, liquid feedstock or powdered solid feedstock at high velocity in the preferred range of 100 to 125 m/s into the bed material to allow effective penetration and mixing. The fluid passages are contained within an outer shell that is cooled with cooling water or other suitable means to protect the materials of construction from the elevated temperature inside the gasifier. Lances do not require any supplemental source of electricity such as for a plasma torch. Lances also do not require ignition devices, a burner management system and fuel/oxidant ratio control (i.e. lambda) as would be the case for a burner.

Tar refers to hydrocarbons having greater than 3 carbon atoms (C3) including oxygenated compounds formed during gasification, e.g. and without limitation, from heterogeneous waste gasification.

### Descriptive Embodiments

In one aspect provided herein is a gasifier preferably for gasifying a heterogeneous waste. In one embodiment, the gasifier is a fixed bed gasifier. In another embodiment, the gasifier is an oxygen blown gasifier. In another embodiment, the gasifier is a slagging gasifier.

In one embodiment, the gasifier comprises one or more locations (e.g., ports) within a vessel. The ports can be configured to provide a stream of heterogeneous waste into the vessel. The one or more ports can be located above a feed bed of the gasifier. The feed bed, among other purposes, feeds the heterogeneous waste, e.g., as a stream into the gasifier.

In another embodiment, the gasifier can include a plurality of lances arranged around the periphery of the gasifier vessel. The lances are useful, e.g., for introducing oxygen and/or steam gasifier reactants into the vessel. In certain embodiments, the lances are arranged at multiple heights with respect to the level of a bed material.

In another embodiment, the gasifier comprises a tar destruction zone located above the bed and within the vessel of the gasifier. In one embodiment, the tar destruction zone can include a plurality of burners arranged around the periphery. In one embodiment, the one or multiple burners are arranged at multiple heights within the tar destruction zone. In certain embodiments, the burners operate above stoichiometric oxygen levels. Stoichiometric oxygen refers to the molar ratio of oxygen required to completely combust one mol of fuel to CO₂ and H₂O. As a non-limiting example, the stoichiometric O₂ requirement to combust one mol of a CₓH_{y} hydrocarbon is equal to x+y/4 mol O₂.

In another embodiment, the gasifier comprises a cooled slag collector. Preferably, the slag collector can be located at the bottom of the bed material. For example, the slag collector can support the bed material. In certain other embodiments, the slag collector comprises at least one slag hole. In certain other embodiments, the slag collector comprises multiple slag holes. The slag holes allow, inter alia, a drainage of slag into a slag reservoir. Preferably, the slag collector is below the slag holes. More preferably, the slag holes allow upward counterflow of gases.

In another embodiment, the gasifier comprises a slag reservoir. In one embodiment, the slag reservoir comprises multiple burners (e.g., a second plurality of burners) and a headspace. Preferably, the burners are positioned within the headspace. Inter alia, the burners maintain the slag temperature. In certain embodiments, the combustion gases of the burners, comprising CO₂ and H₂O, consume or gasify any remaining carbon in the slag prior to slag tapping.

In another embodiment, the lances are offset from the horizontal plane. In another embodiment, the lances are offset from the normal line relative to the internal refractory surface of the gasifier.

In another embodiment, the tar destruction zone has a residence time of at least about 2 seconds and most preferably about 5 seconds to achieve effective tar destruction. As used herein, effective tar destruction refers to destruction of all or substantially all of the tar, so that the syngas can be further processed in heat recovery and solids removal unit operations downstream of the gasifier without fouling from residual tar condensing as the syngas temperature is reduced.

In another embodiment, the tar destruction zone temperature is at least about 2000° F. (1093° C.). In another embodiment, the tar destruction zone temperature is greater than about 2200° F. (1204° C.).

In another embodiment, the tar destruction zone burners are capable of operating with molar oxygen ratio relative to stoichiometric requirements or lambda between about 0.5 to about 6.0. As used herein, a lambda of 1 is defined as oxygen required for complete stoichiometric combustion of the supplemental fuel fed to the burner.

In another embodiment, additional injectants can be introduced to the tar destruction zone through nozzles that do not meet the definition and functionality of a burner. Non-limiting examples of injectants are, oxygen, steam, recycled syngas, and vaporized hydrocarbon wastes.

In another embodiment, the cooled slag collector is internal to the gasifier vessel. For example, the cooled slag collector can be positioned within a cavity defined by the vessel. The cooled slag collector can include at least one cooling feature. The cooling feature can maintain the steel or another type of frame and refractory components within their design temperature limits of less than 350° C. for the steel frame and less than 1760° C. for the refractory components. In another embodiment, the cooled slag collector comprises one or more limpet coils. In another embodiment, the cooled slag collector comprises internal copper coils within the refractory material for cooling. In one embodiment, the cooling is balanced with heat absorbed from the gasifier. For example, heat absorbed from the gasifier can form a protective skull layer within a slag collection hearth zone and inside a slag hole (e.g., slag flow areas). The protective skull layer can minimize erosion and corrosion of a protective refractory and can prevent slag from freezing off (e.g., prevent the freezing off of the slag flow and impeding consistent slag collection).

In another embodiment, the slag reservoir allows slag to be held for an average residence time of greater than 1 hour to ensure complete conversion of residual carbon.

In one embodiment, the gasifier does not comprise a plasma torch. In another embodiment, the gasifier does not comprise a bed permeability additive. An illustrative example of a bed permeability additive is narrow size distribution coke.

In another aspect, provided herein is a syngas composition also referred to simply as syngas, and such other compositions. In one embodiment, the syngas composition is provided by gasifying a heterogeneous waste. In one embodiment, the syngas composition is that exiting the top of the polisher section of the gasifier. In another embodiment, the syngas composition has a tar content less than about 5 g/Nm³. In another embodiment, the syngas composition has a tar content of preferably less than about 2 g/Nm³. In another embodiment, the syngas composition has a carbonaceous soot (including mineral ash) content less than about 10 g/Nm³ and preferably less than about 5 g/Nm³.

In another embodiment, the syngas composition is free or substantially free of soot. In another embodiment, a cyclone is used to recover a portion of the soot particles prior to cooling below about 950° C. In some embodiments, soot is removed by baghouse after cooling of the syngas to about 250° C., but not below the dewpoint of the gas. In some embodiments, soot in the syngas is recovered during wet gas scrubbing, optionally dewatered in a filter, centrifuge, hydrocyclone, flotation cell, or other suitable device, and recycled to the solids feeder of the gasifier. In another embodiment, the soot that is separated during wet gas scrubbing is circulated back to the gasifier as a slurry and injected into the gasifier via one or more lances with liquid injection nozzles.

In one embodiment, provided herein syngas is further converted to hydrogen, synthetic natural gas, methanol, ammonia, liquid fuels, gaseous feedstock for microbial fermentation to produce feed protein, biodegradable polymers, or alcohols, comprising or produced from the syngas composition provided herein.

In one embodiment, provided herein a CO₂ co-product with purity greater than about 95% and preferably greater than about 99.5% is recovered from purge or tail gas following conversion of syngas to products.

In one composition embodiment, the slag produced by gasification of heterogeneous waste in a gasifier provided herein is non-leaching according to TCLP testing. In another embodiment, the provided herein is a road base or cement additives comprising the slag provided herein.

In another aspect provided herein is a process of gasifying heterogeneous waste. In one embodiment, the process comprises gasifying the heterogeneous waste in a gasifier provided herein. In another embodiment, the heterogeneous waste material requires no or substantially no pre-processing, limited to removal of large items that cannot be shredded, metal, rocks and hazardous materials such as explosives. In another embodiment, the heterogeneous waste material requires only basic shredding to a preferred size range of about ¼″ to about 2″ (6 mm to 50 mm). In another embodiment, the heterogeneous waste material requires drying only if the moisture content is greater than about 20% by weight.

In another embodiment, the oxygen to steam ratio used in the lances located within the bed of material is in the range of about 1.5 to about 4.5 kg O₂/kg steam.

Certain non-limiting advantages A-C of the technologies provided herein are described hereinbelow.
A. They provide an ability to control the slag chemistry to produce a vitrified glassy slag material where impurities are fully immobilized and non-leachable. This allows the slag to be used beneficially in commercial applications such as for road base. In contrast, ash produced with lower temperature gasification contains leachable toxic elements and has to be frequently disposed of in a hazardous landfill.
B. They substantially reduce high tar content typically present in the syngas from a fixed bed updraft gasifier without need for costly downstream tar separation and recovery unit operations. Gasification of heterogeneous waste in an updraft gasifier is accompanied by generation of significant levels of tar in the syngas. For certain heterogeneous waste and biomass gasifiers, the production of excessive tar is a serious problem resulting in fouling of process equipment and despite best efforts to prevent such accumulation using sonic horns, scraper, or high velocity jets costly shutdowns for routine cleaning cannot be avoided.
C. They allow gasification of heterogeneous waste streams with high volatile matter content, wide particle size distribution between about 6 to about 100 mm (about ¼″ to about 4″) and ability to handle high fines content (e.g. >about 10% material of <about 6 mm) with minimal pre-processing in a fixed bed, oxygen blown slagging gasifier without any assistance from plasma torches and supplemental bed permeability agents such as coke or coal.

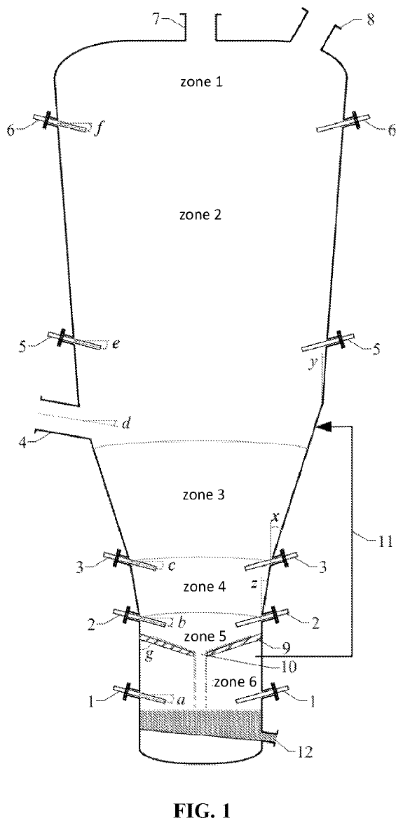

FIG. 1 illustrates an embodiment of a gasifier of the current invention in elevation and cross section. The gasifier converts a carbon containing feedstock including but not limited to municipal solid waste (“MSW”), wood, agricultural waste, coal, petcoke or hydrocarbon to synthesis gas (“syngas”) which is comprised of CO, H₂, CO₂, H₂O, CH₄ C2 and higher hydrocarbons including condensable hydrocarbons heavier than C3 compounds (i.e. tar) and solids carried over with the syngas comprising carbonaceous soot and mineral ash components.

In general, components such as lances, ports and burners have multiple units and any references to singular items should be understood to apply to multiple units as well. Any references to singular or plural components are in no way meant to limit the scope of the description.

In some embodiments, the gasifier has an outer shell or wall constructed of refractory lined steel with outer cooling jackets in some of the sections as required to maintain temperatures within the design specification of the materials of construction. The gasification occurs in several major sections that each fulfills a distinct function with the overall objective to convert the feedstock into tar-free syngas and molten slag.

In some embodiments, the gasifier of the current invention is further characterized by having variable diameter and side walls that can be vertical or conical with slopes selected to optimize the gas and solids flow in each zone as well as residence times. The sidewall angles off the vertical, as highlighted in FIG. 1, are generally between about 5° and about 250 and optimized based on feedstock characteristics and desired residence time and aspect ratio for each of the zones. The current invention is not limited by any specific set of geometric features but as would be understood by those skilled in the art, it is desirable to optimize residence time, superficial gas velocity and bed H/D to provide sufficient residence time while maintaining desired fluid flow regimes with fully developed gas flow (i.e. sufficient bed height to ensure full distribution and reaction of gases without channeling and premature breakthrough) while staying below fluidization velocity and limiting carryover of solids into the syngas.

In some embodiments, the solid feedstock is fed into the gasifier above the bed of material in zone 3 via one or more ports 4 using a suitable solids feeder. Any suitable solids feeding arrangement can be used including without limitation a) pneumatic, b) series of lock hoppers and slide valves, c) a rotary feeder also known as a star feeder or d) a screw feeder. A particularly preferred feeder is a plug screw feeder that has a conical screw section to compress the feed material and create an effective gas barrier between the feed system and gasifier. The screw feeder has an optional extension on the inside of the gasifier to feed material towards the center of the bed of material for improved distribution and gasification efficiency. Additional feedstock can optionally be fed from the top of the gasifier via feed port 7 as required to ensure even distribution across the cross section of the gasifier. If required, bed additives or fluxing agents can also be fed via port 7 to adjust bed permeability or slag characteristics as desired for stable operations.

In some embodiments, the feedstock fed into zone 3 is heated by rising hot synthesis gas (“syngas”) produced by the gasification reactions in zone 4 which results in drying, devolatilization and pyrolysis of the feedstock. Without being bound by theory, pyrolysis is a set of chemical reactions that occurs in the absence of oxygen and converts the solid feedstock into a) H₂O vapor from evaporation of free water and chemical dehydration reactions, b) permanent gases including CO, CO₂, H₂ and CH4, C2/C3 hydrocarbons (“HC”), c) tar compounds that have a general formula of CHₓO_{y}, where x and y are decimal numbers as will be apparent to the skilled artisan, and d) solid char. The solid char generally has carbon content above about 90% or about 95% but still contains covalently bound oxygen and/or hydrogen. Without being bound by theory, it is generally desired to maintain a relatively slow heating rate to the ultimate peak gasification temperature to allow for controlled pyrolysis in the upper sections to minimize tar generation and maximize secondary char or carbonaceous solid carbon formation that provides the substrate for the lower oxygen gasification reactions. The heating rate is primarily controlled by the bed level or bed volume in zone 3 with a high bed level providing increased residence time and slower heating rates. Preferred heating rate in zone 3 is less than about 10° C./min, less than about 7.5° C./min or less than about 5° C./min.

In some embodiments, the solid char stripped of its volatile matter descends into zone 4 where gasification reactants, oxygen and steam, are injected in a controlled ratio via an upper set of lances 3 and a lower set of lances 2. Providing injection points for the gasification reactants at different heights provides improved distribution and ensures steady movement of bed material to maintain uniform gasification and even distribution of produced syngas across the cross section of the bed to prevent channeling and potentially hazardous conditions associated with breakthrough of oxygen. Gasification reactions are well known by those skilled in the art and can include, without limitation, the following reactions:

Solid carbon gasification reaction C+½O₂→CO (Rxn. 1)

Solid carbon Boudouard reaction C+CO₂→2 CO (Rxn. 2)

Solid carbon water gas reaction C+H₂O→CO+H₂ (Rxn. 3)

Gas phase CO combustion CO+½O₂→CO₂ (Rxn. 4)

Gas phase CO water gas shift (“WGS”) CO+H₂O→CO₂+H₂ (Rxn. 5)

Steam reforming of hydrocarbons CₓH_{y}+x H₂O→x CO+(x+y/2) H₂ (Rxn. 6)

Reaction 1, 4 and 5 are exothermic (i.e. releases heat) to achieve the elevated gasification temperatures and provide heat to support the endothermic reactions 2, 3 and 6. An objective of the gasifier of the current invention is to achieve full conversion of all mineral and ash content into fully vitrified slag and also melt any incidental metals present in the feedstock. In some embodiments, achieving this key objective requires temperature in excess of about 1500° C., preferably in excess of about 1750° C. up to about 2000° C. directly in front of the lances 2 and 3. The high temperature zones directly in front of the lances 2 and 3 within zone 4 are referred to in the art as the tuyere zones or lance raceway zones that extend from the injection point into the bed of material with a raceway length of greater than about 1 ft., greater than about 2 ft or even greater than about 3 ft dependent on bed permeability characteristics, peak temperature as well as injection velocity of the reactants from the lance. The reactants are injected at a velocity in the range of about 75 to about 150 m/s and in a preferred range of about 100 to about 125 m/s, e.g., to optimize effective penetration into the bed and to provide effective contact of the gasification reactants with the carbonaceous char by inducing recirculation while limiting wear of the refractory wall and lance tips. The syngas produced in zone 4 rises through the bed into zone 3 providing the heat for drying, devolatilization, and pyrolysis of the feedstock.

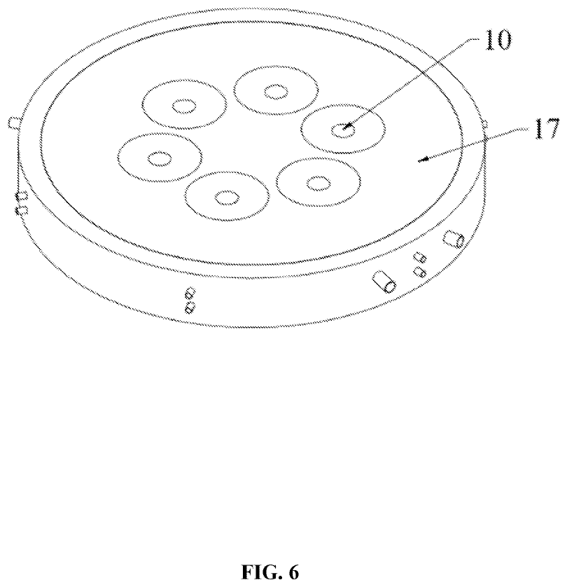

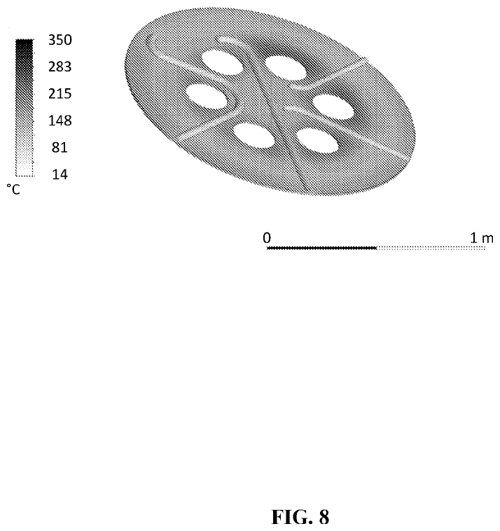

Another objective of the gasifier of the current invention is to maximize the conversion of carbon and produce a molten slag with well controlled glassy (i.e. non-crystalline) structure and minimal carbon content that can be separated and collected effectively from a bed of heterogeneous feed material without requiring costly and non-sustainable bed permeability agents such as a coal or coke. In some embodiments, this objective is achieved by having an actively cooled conical bed support structure (referred to as the cooled slag collector or “CSC”) positioned above the molten slag reservoir zone 6 and that separates the headspace of the slag reservoir zone 6 from the slag collection hearth zone 5 while maintaining upward flow of combustion gases from the oxyfuel burners 1 through the center of the slag holes 10 (FIG. 6) and gravity annular flow of slag from the collection or hearth zone 5 down the walls of the slag holes 10 draining into the slag reservoir zone 6. The CSC has a supporting steel plate 16 welded to a ring or wafer body that is mounted between the main body break flanges of the gasifier to allow for ease of removal and servicing. The CSC has one or more slag holes 10 and is provided with limpet coils welded to the plate and optional helical cooling coils surrounding the slag holes to provide cooling and maintain the structural metal within its design temperature limits and additionally form a protective slag skull on the surface of the refractory according to design principles known by those skilled in the art to extend the refractory life. FIG. 8 depicts the temperature profile of the upper surface of the structural steel plate 16 from a computational fluid dynamics (“CFD”) analysis conducted with Ansys Fluent to evaluate the effectiveness of the limpet coils welded directly to the bottom surface. The modeling confirmed the feasibility of maintaining the steel temperatures within the design limit of 350° C.

In one embodiment the CSC is an internal feature as highlighted in FIG. 1 (i.e. analogous to a false bottom) with the external wall of the gasifier that remains substantially vertically oriented. As would be appreciated by those skilled in the art this is of benefit for a pressurized gasifier where a conical external wall is not desirable.

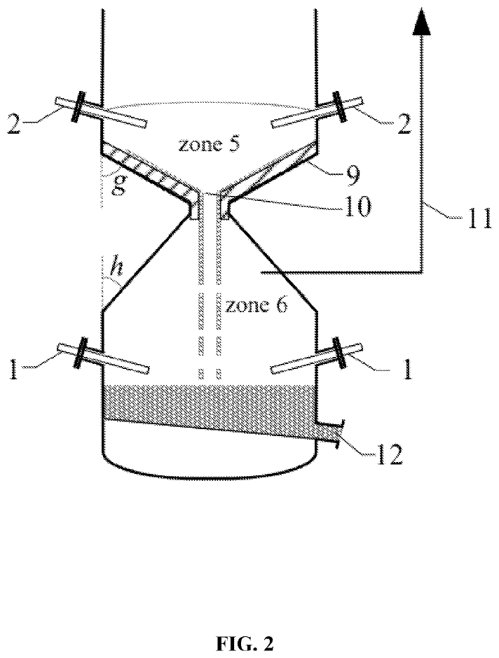

In another embodiment, depicted in FIG. 2, the CSC 9 is integrated with the vessel outer body and the slag hole 10 is located at the apex of the conical section leading slag to drain into the slag reservoir zone 6. This particular configuration will typically only feature a single slag hole unlike the internal CSC where the number of slag holes is not generally limited. In this design all cooling features, with the exception of the central slag hole cooling features, are external to the vessel, resulting in a simpler design with fewer concerns about internal leaks of cooling water into the gasifier. The central slag hole and associated cooling features are combined into a compact assembly that is designed as a wafer body to be inserted between two much smaller body flanges compared to FIG. 1. These benefits have to be weighed against the added complexity of designing the lower zone 5 and upper zone 6 outer conical walls with respective angles of g° and h° and the associated complexities for cooling and refractory installation.

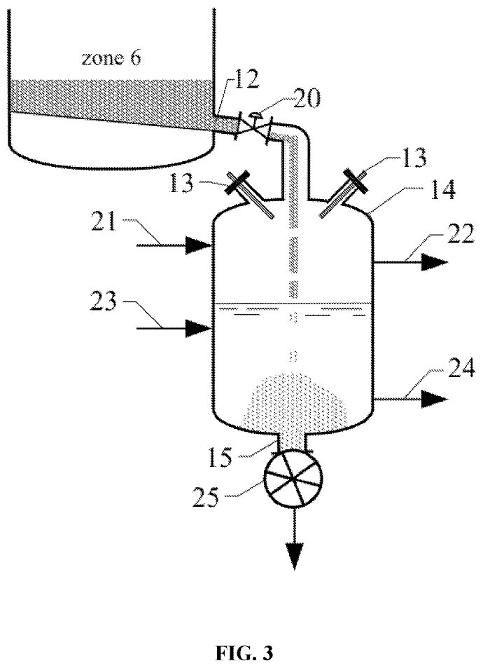

In another embodiment, depicted in FIG. 3 the rate of discharge of molten slag through the taphole 12 depicted in FIG. 1 is controlled to maintain a constant slag level in zone 6. This is achieved by balancing the pressure drop through 12 with the internal pressure within the gasifier. In some embodiments, the pressure drop is controlled by a mechanical device 20, such as a mechanical valve, to restrict the size of the taphole opening. For example, the mechanical valve can restrict the size of the taphole based on a pressure differential across the taphole. In some embodiments, another vessel 14 is added and pressurized with an inert gas stream, a non-limiting example being N₂, via inlet 21 or depressurized via vent 22, the combined action controlling the pressure drop across 12 to control slag level in zone 6. For example, the additional vessel 14 can enclose slag discharge and can include an inert gas to create a pressure within the additional vessel 14, where the pressure of the additional vessel 14 can control or affect the pressure differential across the taphole.

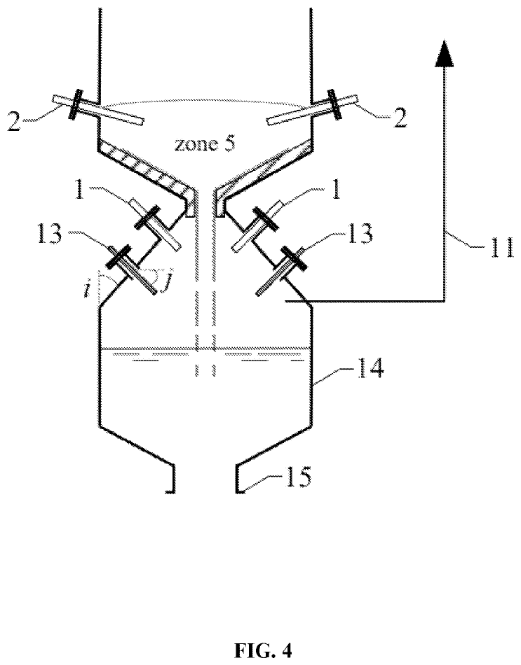

In another embodiment, depicted in FIG. 4, a quench chamber is provided below zone 5. In this case, the slag hole 10 is now effectively a taphole with taphole burners 1 being used to control slag flow and temperature via the taphole. Slag flowing through the taphole is quenched using recirculating water via spray nozzles 13 forming a granulated slag with typical particle size <6 mm and collected under water in a quench chamber 14 from where it is discharged with a rotary feeder or similar device via port 15.

In certain embodiments, the CSC is equipped with multiple slag holes. Without wishing to be bound by theory, multiple slag holes around the periphery of the CSC can disrupt core flow of the solids in the bed and redirect the solids towards the outer diameter and active lance raceways, ensuring material movement across the entire cross section of the gasifier enabling gasification of heterogeneous materials without requiring expensive and energy intensive feed preparation such as pelletizing or briquetting or the use of bed permeability additives such as coal or coke co-feed for stable operation.

In some embodiments, oxyfuel burners 1 are provided in the headspace of the slag reservoir zone 6 to ensure slag remains in the optimal temperature regime for tapping via the slag taphole 12, typically in the range from about 1250° C. to about 1500° C. The temperature can be controlled via modulation of the burners to maintain the optimal viscosity for tapping and granulation without causing excessive corrosion or erosion of the refractory resulting from excessive slag temperature. The combustion gases of the oxyfuel burners, CO₂ and H₂O above about 1500° C., maintain the desired slag temperature and also react with residual carbon or particles that may have dropped through the slag holes and will float freely on the slag surface given high specific gravity of molten slag. Without being bound by theory, these endothermic gasification reactions of carbon with CO₂ and H₂O results in very high conversion of carbon into additional syngas CO and H₂ and results in a slag with minimal carbon content to ensure full vitrification of mineral matter in a glassy slag structure that is well suited for downstream market applications such as road base or cement additives.

In some embodiments, the desired gasification temperature within the gasification zone 4 is controlled by the amount and ratio of oxygen and steam reactants being injected via the lances 2 and 3 as well as supplemental heat provided by the oxyfuel burners 1 in the headspace of the slag reservoir zone 6. As would be understood by those skilled in the art, the ratio of oxygen and steam being injected controls the relative contributions of the endothermic and exothermic reactions as listed in reactions 1 to 6 to achieve the desired temperature for effective gasification and slagging. The combustion gases from the headspace of zone 6 is generally controlled within a temperature range of about 1500° C. to about 1750° C. and flows upwards through the center of the slag holes 10 into zone 4 with a by-pass line 11 that allows flow into zone 2 to control differential pressure as required. The temperature in the lance raceways can exceed 2000° C. but endothermic reactions with CO₂ and H₂O (Rxns. 2 and 3) present in the combustion gases from burners 1 as well as steam injected via lances 2 and 3 result in the final syngas emerging from zone 4 at a temperature less than about 1500° C., less than about 1250° C. or less than about 1000° C. This syngas exchanges heat with the bed material in zone 3 to support the drying, devolatilization and pyrolysis reactions and enters the tar destruction or polisher zone 2 at a typical temperature less than about 600° C., less than about 500° C. or even less than about 400° C. depending on moisture and volatile matter content of the feedstock.

Another objective of the current invention is to reduce the high tar content characteristic of upflow gasifiers in the range of about 100 to about 200 g tar/Nm³ to less than about 5 g tar/Nm³, less than about 2 g tar/Nm³ and most preferably less than about 1 g tar/Nm³ (tar being defined as hydrocarbons heavier than C3 compounds) without the use of a catalyst or tar chemical absorption and recycle process methods. This objective is accomplished by heating the syngas to a temperature greater than about 1000° C., greater than about 1100° C., and preferably greater than about 1200° C. via reaction with additional oxygen supplied e.g. by burners 5 that are designed to be operated with significant excess stoichiometric oxygen with lambda greater than about 1.0, greater than about 1.5, greater than about 2.5 or greater than about 5.0 as required to balance the heating provided via combustion of supplemental fuel gas versus partial oxidation of tar species in the syngas. Tar content can be very variable depending on feedstock composition and at high tar content most of the heating required to achieve the target temperature is provided by tar partial oxidation (“POX”) reactions vs. combustion of supplemental fuel gas. Burners are used rather than lances to provide very high temperature oxygen. Without wishing to be bound by theory it is believed that contacting very high temperature oxygen with hydrogen and steam results in the generation of hydroxyl and other reactive radicals that promote effective conversion of tar, without any added catalyst, to additional syngas CO and H₂ according to the following generic reaction (not balanced).

Tar POX and steam reforming CₓH_{y}O_{z}+O₂+H₂Oà CO+CO₂+H₂+soot (Rxn. 7)

The side wall slope y and height of the tar polisher zone 2 is selected to achieve a residence time at temperature of greater than about 2 seconds, greater than about 3 seconds, greater than about 4 seconds and preferably greater than 5 seconds. The POX reactions generate additional syngas resulting in increased in gas flow. The sidewall slope y is selected to counter this effect by increasing the cross-sectional flow area over the height of the polisher section 2 to maintain the superficial velocity within an acceptable range, determined in part by the maximum size solid particle that will be carried over with the syngas. Through careful control of residence time, temperature as well as oxygen and steam addition, it has been found that the tar content less than about 2 g/Nm³ and preferably less than about 1 g/Nm³ can be achieved consistently with minimal level of soot as a by-product typically less than about 10 g/Nm³, less than about 7.5 g/Nm³ and preferably less than about 5 g/Nm³. Syngas with low tar content has significant benefits for further downstream processing unit operations including solids removal and waste heat recovery by limiting fouling, improving overall reliability and online time as well as maintaining peak operating efficiency of these unit operations. It has been found that the above objectives can be achieved with minimal combustion losses of CO and H₂ already present in the syngas and through careful experimentation it has surprisingly been found that most of the supplemental heat is derived from tar reactions rather than the incoming CO and H₂. Without wishing to be bound by theory it is believed that the highly energetic free radicals that are likely generated from H₂ in the presence of hot oxygen subsequently reacts with tar species provided good contact is provided. During these reactions, the tar is converted to syngas and the energy content of the free radicals is captured as chemical bonds rather than converted to heat (i.e. combustion).

The syngas, now essentially tar-free, leaving zone 2 contains low levels of ash components that can create sticky deposits and fouling in downstream heat recovery and solids removal equipment.

In some embodiments, to prevent fouling from these sticky ash components, the syngas is quenched in zone 1 using water injected via spray nozzles 6 to an intermediate temperature typically less than about 800° C. before exiting the gasifier via ports 8. To avoid fouling and deposits in the spray nozzles, demineralized water is preferably used.

In some embodiments the syngas is not quenched in zone 1, and upon exiting port 8 enters a cyclone to remove and recover carbonaceous particulate matter from the syngas prior to substantial cooling. Those skilled in the art would recognize that recovery at high temperature results in less contamination by condensed alkali salts, examples of which are K₂O, Na₂O, KCl, NaCl. The recovered particulate is suitable for reintroduction to the gasifier.

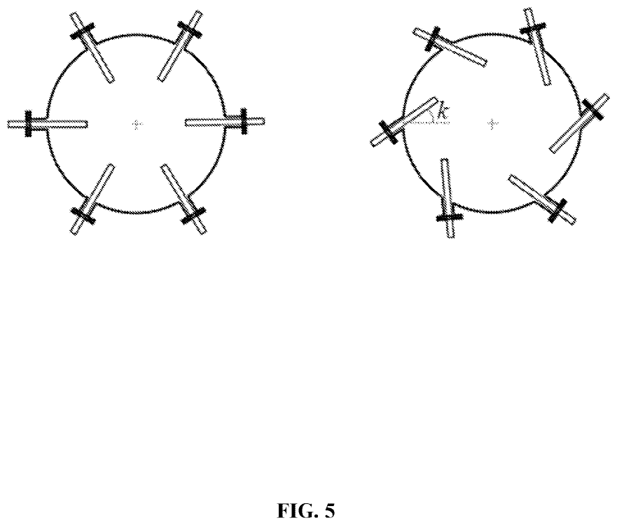

In some embodiments, the lances and burners in each of the zones can be angled both with respect to the horizontal plane and the normal line (a line perpendicular to the tangent of the inside refractory wall) as indicated in FIG. 1 and FIG. 5. The gasifier of this invention is not intended to be limited by any particular set of angles as these can be optimized for each situation by a person skilled in the art, depending on feedstock composition and desired injection velocities and angles in different zones. Without limiting the foregoing, the typical range of these angles is between about 0° and about 25°.

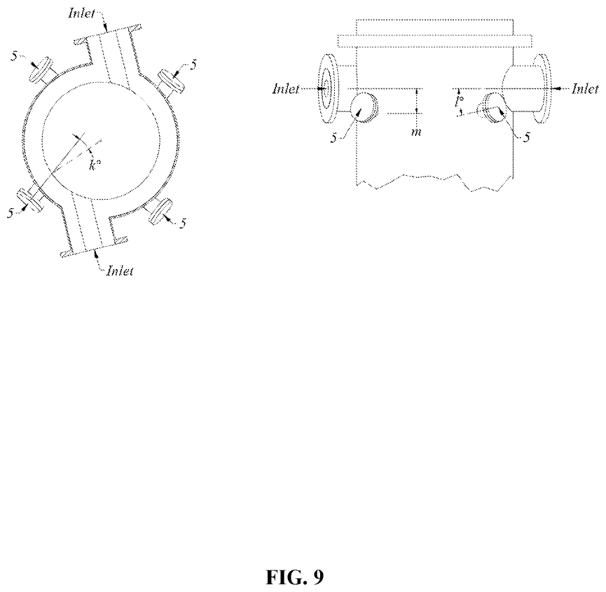

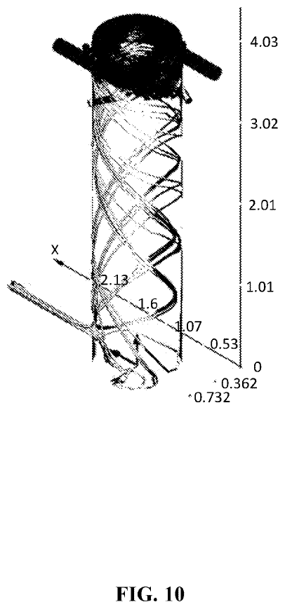

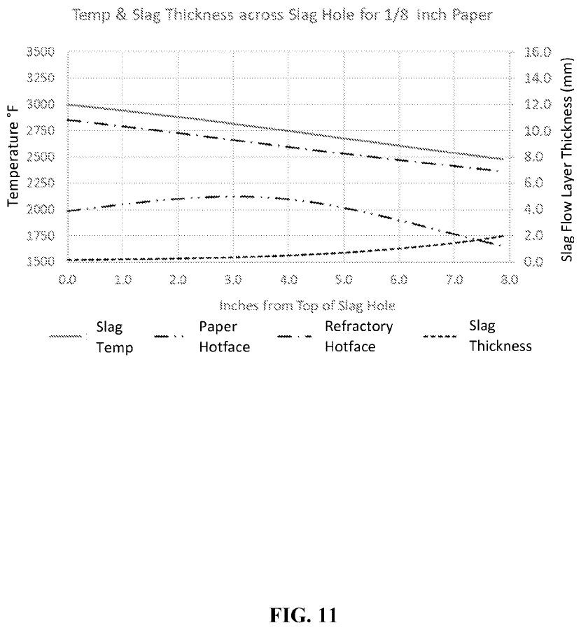

In a non-limiting example that merely serves to exemplify the impact of varying the angular orientation of the burners or lances, a separate tar polisher was installed to treat syngas from a gasifier without an integrated tar polisher zone 2. Syngas leaving zone 3 is directed to a separate polisher after exiting the gasifier via ports 8. The polisher inlets and burners are shown in schematic plan view in section in FIG. 9. The burners 5 are offset from both the horizontal plane and normal line with angles 1° and k° respectively. A CFD analysis was performed, and as shown in FIG. 10 a defined swirling pattern was created that ensures good mixing and contact of the tar species with the hot reactants produced by the excess lambda burners 5.

### EXAMPLES

### Example 1: Tar Conversion Using a Separate Polisher with Excess Lambda

burners. Municipal solid waste (MSW) derived pellets with composition in Table 1 was fed to at a rate of 120 kg/hr. into a demonstration-scale gasifier with a hearth internal diameter of 40″ (1.0 meter) and overall height of 15′ (4.6 meter). Oxygen was fed through the lances at a rate of 30 kg/hr. with the lance oxygen to steam ratio set at 2.4 (m/m) or a steam flowrate of 12.5 kg/hr. The tar-laden syngas containing 150 g/Nm³ tar (defined as hydrocarbons >C3 plus all oxygenated species) exiting the top of the gasifier was fed directly into a separate tar polisher vessel via two inlets arranged tangentially as shown schematically in FIG. 9. The polisher was equipped with four (4) burners 5 as shown in FIG. 9. The burners were used to control the polisher temperature at the desired setpoint 1093° C. (2000° F.) with propane used as supplemental fuel. Excess oxygen (i.e. over and above stoichiometric requirements to combust supplemental fuel) of 20 kg/hr. was fed to the burners.

### REPORT OF ANALYSIS

Lab Number, R9678
Sample ID: SW Pellets 2/20/20 1900

| Proximate | As Received | Moisture Free | Moisture & Ash | ASTM | Date | |
|---|---|---|---|---|---|---|
| Analysis | wt % | wt % | Free wt % | Method | Analyzed | Analyst |
| Moisture | 2.33 | ***** | ***** | D7582 | Mar. 9, 2020 | MP |
| Ash | 10.54 | 10.79 | ***** | D7582 | Mar. 9, 2020 | MP |
| Volatile Matter | 81.73 | 83.68 | 93.80 | D7582 | Mar. 9, 2020 | MP |
| Fixed Carbon | 5.40 | 5.53 | 6.20 | calculated | | |
| Total | 100.00 | 100.00 | 100.00 | | | |

| Ultimate | As Received | Moisture Free | Moisture & Ash | ASTM | Date | |
|---|---|---|---|---|---|---|
| Analysis | wt % | wt % | Free wt % | Method | Analyzed | Analyst |
| Moisture | 2.33 | ***** | ***** | D7582 | Mar. 9, 2020 | MP |
| Ash | 10.54 | 10.79 | ***** | D7582 | Mar. 9, 2020 | MP |
| Carbon | 49.60 | 50.78 | 56.93 | D5373 | Mar. 2, 2020 | MP |
| Hydrogen | 7.05 | 7.22 | 8.09 | D5373 | Mar. 2, 2020 | MP |
| Nitrogen | 1.34 | 1.37 | 1.54 | D5373 | Mar. 2, 2020 | MP |
| Sulfur | 0.35 | 0.358 | 0.40 | D4239 | Mar. 2, 2020 | MP |
| Oxygen | 28.79 | 29.48 | 33.04 | calculated | | |
| Total | 100.00 | 100.00 | 100.00 | | | |

| | As Received | Moisture Free | Moisture & Ash | ASTM | Date | |
|---|---|---|---|---|---|---|
| | Btu/lb | Btu/lb | Free Btu/lb | Method | Analyzed | Analyst |
| Heating Value | 9,030 | 9,245 | 10,364 | D5865 | Mar. 4, 2020 | MP |

Hydrogen and Oxygen values reported do not include hydrogen and oxygen in the free moisture associated with the sample.
Reported results calculated by ASTM D3180. Results are an average of 2 runs.

Samples of syngas exiting the polisher were collected and analyzed using EPA Method TO-14 and analyzed with GC/FID to detect all species heavier than methane. For the purposes of reporting tar content, the C2 and C3 species (>90% ethane with minor quantities of ethylene and propane) were excluded. Tar is generally understood to refer to condensable components and the C2 and C3 components above remain as permanent light gases in the syngas.

TABLE 2
Polisher tar destruction based on EPA TO-14 tar analysis

| | | |
|---|---|---|
| Tar-laden syngas from gasifier | 150 | g/Nm³ |
| (measured with 3 impinger bottles at 4° C.) | | |
| Polisher syngas EPA TO-14 | | |
| Total tar species | 1.2 | g/Nm3 |

| | |
|---|---|
| Aromatics (only benzene and naphthalene detected) | 84% |
| Paraffins | 15% |
| Olefins | 1% |
| Total tar destruction | 99.2% |

Soot content was estimated via a filtration test to be in the range of 4 to 5 g/Nm³ confirming that all of the condensable tar species were effectively destroyed. Any tar that was not converted to syngas or light alkanes was converted to soot that was readily separated in the wet gas scrubbing section of the process. Essentially no condensable polyaromatics, hydrocarbons, or any chlorinated hydrocarbons were detected confirming the effectiveness of the polisher to convert tar species to valuable syngas components without generation of hazardous by-products. The soot is recovered, dewatered, and then recycled to the gasifier such that no waste stream is generated.

### Example 2: Modeling and Testing of CSC Slag Hole to Assess Slag and Refractory Temperatures and Slag Flow

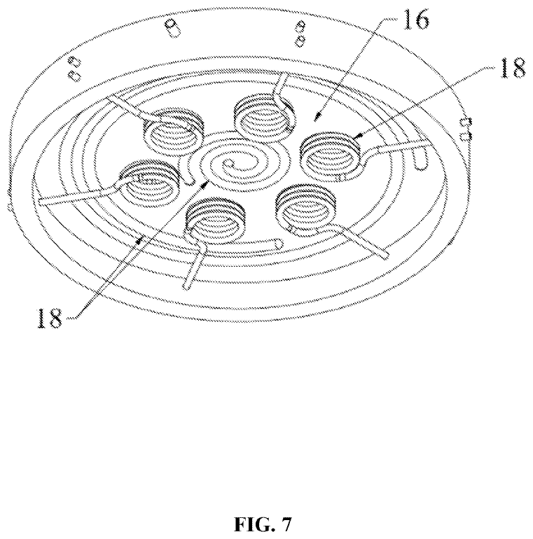

The cooled slag collector (CSC) as depicted in FIGS. 6 and 7 was modeled to assess the temperature profiles of the flowing slag as well as refractory in a single slag hole. The inner diameter of the slag holes 10 was set at 3″ and the total slag hole length was set at 8″. A cooling coil 18 with tube diameter of ¾″ and a single loop with diameter of 8″ was located directly on the steel plate 16 (i.e. 2.5″ of refractory between flowing slag and cooling surface).

A spreadsheet model was developed with stepwise integration of heat flow from the top of the hole to the bottom. The key model input parameters are highlighted in Table 3.

TABLE 3
CSC slag hole model parameters and calculation approach

| | |
|---|---|
| Slag temperature entering | 1650° C. (3000° F.) |
| top of slag hole | |
| Combustion gases entering | 1482° C. (2700° F.) |
| bottom of slag hole | |
| Refractory | Jadeshot 50% chrome (HarbisonWalker) |
| Refractory conductivity | 2.7 W/m² K |
| Insulating paper conductivity | 0.1 W/m² K |
| Slag viscosity | See, Mills, K. C. et al. (October 2011) |
| | Estimating the physical properties of |
| | slag. The Journal of the Southern |
| | African Institute of Mining and |
| | Metallurgy, Volume 111, Page No. |
| | 649-658. Incorporated herein in its |
| | entirety by reference. |
| Slag T250 (temperature with | 1100° C. (2012° F.) |
| viscosity of 250 Poise) | |
| Heat transfer film coefficient | 100 W/m² K (See Nelson and |
| for flowing slag | Hundermark, supra) |

The calculation was set-up in polar coordinates to account for changing cross sectional area for heat flow as a function of radius. A step size of 0.1-1 mm was used to integrate across the full length of the hole. As is typical for counterflow heat transfer calculations (boundary temperature conditions for slag and combustions gases are at opposite sides) an iterative calculation is required to solve the problem. This was set-up in the spreadsheet using techniques known to those skilled in the art.

The slag viscosity is very sensitive to temperature and was calculated based on laboratory T250 measurement (temperature at which viscosity=250 Poise) with correction to other temperatures based on correlations developed by Mills et al., supra. It should be noted that the T250 of the slag at 2012° F. is lower than that of the MSW ash of 2118° F. as reported by the analytical laboratory and summarized in Table 5. The addition of CaCO₃ slag additive modifies the optical basicity and reduces the viscosity by breaking the SiO₂ network. The MSW pellets had an ash content of 10.8% (see Table 1) and additional CaCO₃ added was 1.7% (relative to MSW). The resulting slag viscosity incorporating the added CaCO₃ is summarized in Table 4 and had a calculated optical basicity of 0.638 including the CaCO₃.

The flowing slag film thickness was calculated using the correlations for annular flow for drainage systems with counterflow of air in tall buildings. See Buitenhuis, M. (2017), What flow rates can go through a drainage system—a theoretical background, pages 24-28. https://high-rise.aliaxis.com/wp-content/uploads/Research-What-flow-rates-can-go-through-a-drainage-system-09-17-132-1.pdf, incorporated herein by reference in its entirety.

TABLE 4
Slag viscosity for MSW pellets with 1.7% added CaCO₃

| Temp C. | Temp F. | Viscosity Poise |
|---|---|---|
| 1100 | 2012 | 250.00 |
| 1200 | 2192 | 105.77 |
| 1300 | 2372 | 32.28 |
| 1400 | 2552 | 11.40 |
| 1500 | 2732 | 4.54 |
| 1600 | 2912 | 2.00 |

It was quickly established that a layer of insulating paper would be required to prevent excessive cooling and freezing of the slag in the slag hole. The final solution shown in FIG. 10 used ⅛″ of insulating paper to ensure the cooling effect is targeted to the structural steel without freezing off slag in the slag hole. As is evident from FIG. 10 the refractory hotface is maintained below 2900° F. at the top of the slag hole and above 2200° F. at the bottom of the slag hole. This ensures that the refractory is maintained within its design limits of 3200° F. but always hot enough to ensure a slag viscosity below 100 Poise (10,000 cP). The insulation paper is also maintained well below its design limit of 2200-2500° F. Temperature values in centigrade (C) and Fahrenheit (F) are related by the equation C= 5/9(F-32).

As confirmed via the modeling, it is feasible to separate and collect slag into a slag reservoir via the CSC of the current invention and maintain all materials within their design limits and also prevent slag from freezing off.

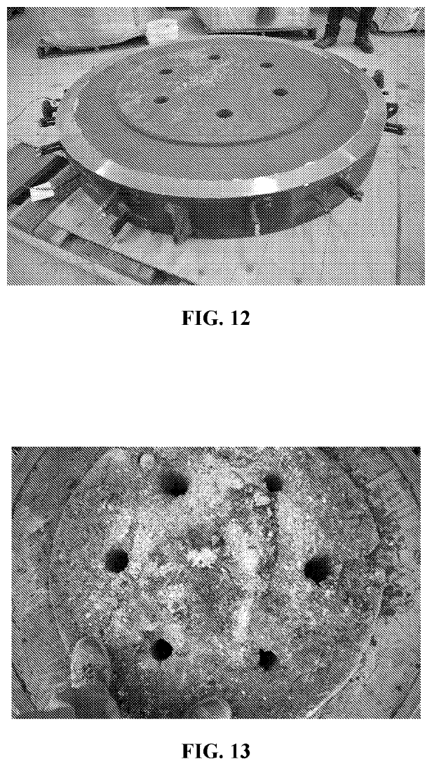

The CSC was fabricated and tested in the gasifier of example 1. Before and after photos of the CSC, FIG. 12 and FIG. 13 respectively, are presented from an operational test of the device. There is no evidence of slag freezing in the slag holes 10 of the device

### Example 3: Design and Modeling of the Scaled-Down Commercial CSC

The CSC of example 2 containing six (6) 3″ ID slag holes 10 was successfully designed, built, and tested in the demonstration-scale gasifier. The focus with this 1^{st} generation CSC was to ensure that slag viscosity remained low enough (below 100 Poise) so no significant ‘freeze layer’ or ‘skull’ would form and continue to build-up, potentially completely blocking the holes. However, there is evidence of erosion of the refractory in the holes as can be identified in FIG. 13. The next generation of CSC to be modeled and designed, was to incorporate features that would be present in commercial deployments of the technology, being (i) a single (1) slag hole in the center of the gasification vessel, and (ii) the component should actively produce and maintain a skull layer of slag over the upper surface of the CSC and inside the slag hole, to better insulate and protect the CSC component/materials of construction from erosion and temperature departures.

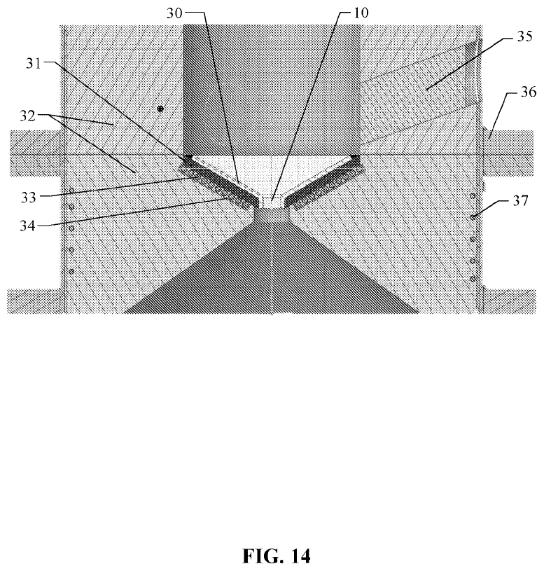

Simulations were produced in ANSYS Fluent to analyze and tailor the materials of construction selected, location of cooling circuits, dimensions of all components and operating flowrates under various scenarios/case studies. FIG. 14 shows a representative, but not limiting example of such a design. The upper surface of the CSC component has a silicon carbide based ceramic insert 31, which provides high thermal shock resistance and high conductivity, allowing sufficient heat removal from the flowing molten slag, to cool it enough to promote, form and maintain a slow-moving, lower-temperature, lower-conductivity protective skull layer. At the center of the conical silicon carbide insert 31 is the 3″ slag hole 10. Copper tubing provides the cooling circuits 33 to remove approximately 200,000 BTU/hr. of heat, enabling the skull formation. Coolant velocities (modeled as pure water in these simulations) are maintained in a range of 10 to 30 ft./s, and a pressure of 50 psig to prevent local film boiling.

The shell (and vessel break flanges) 36 are protected from the high process temperatures, by a selection of refractory and insulating fabrics 32, and also by cooling circuits 37 that in this design are placed on the inside of the vessel. Future designs, with more vertical space available could have external cooling (limpet coils or dimple jackets) affixed to the outside of the vessel shell 36.

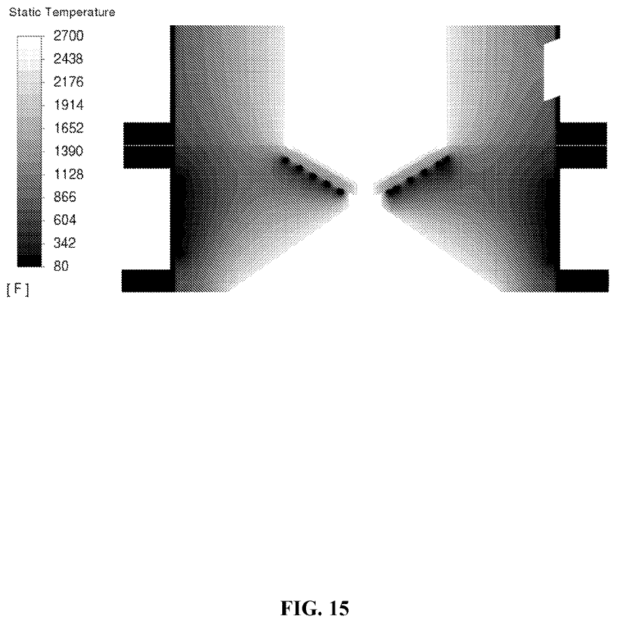

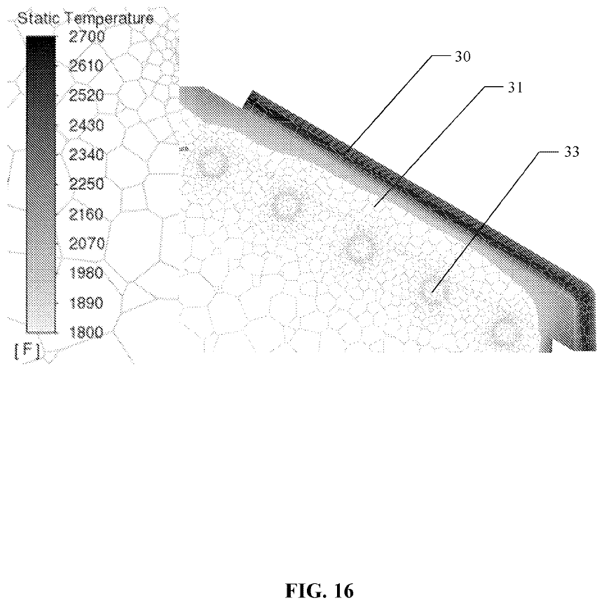

In FIG. 15 the temperature results for one CSC design are displayed, with temperature contour range being a low of 80° F. (black coloring) to 2700° F. (light gray coloring). A corresponding image, FIG. 16 is zoomed-in to the silicon carbide insert 31 and flowing slag region 30 with temperatures contours being displayed for 1800° F. (light gray coloring) to 2700° F. (black coloring), with temperatures below 1800° F. display as white. 1800° F./982° C. is selected as for most fluxed slag compositions encountered during the processing of waste materials, temperatures below this level lead to significant increases in viscosity, and essentially ‘frozen’ skull formation. As can be seen in FIG. 16, this specific design configuration leads to molten slag essentially remaining above this 1800 F threshold, so no frozen skull would be generated in this instance, and unacceptable condition.

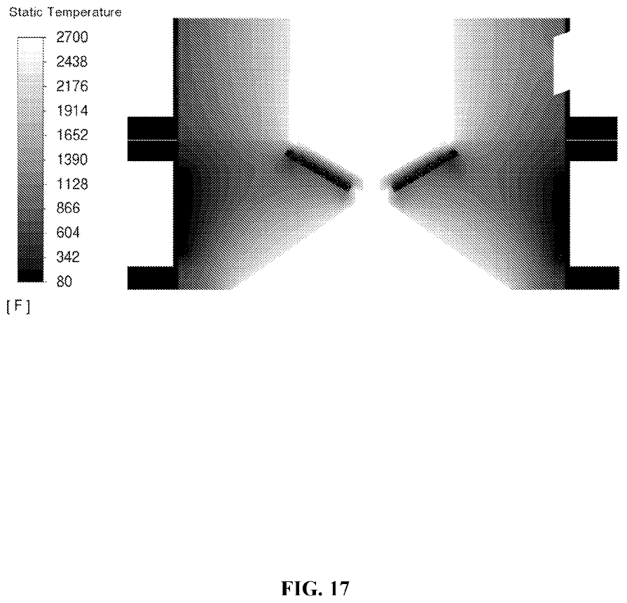

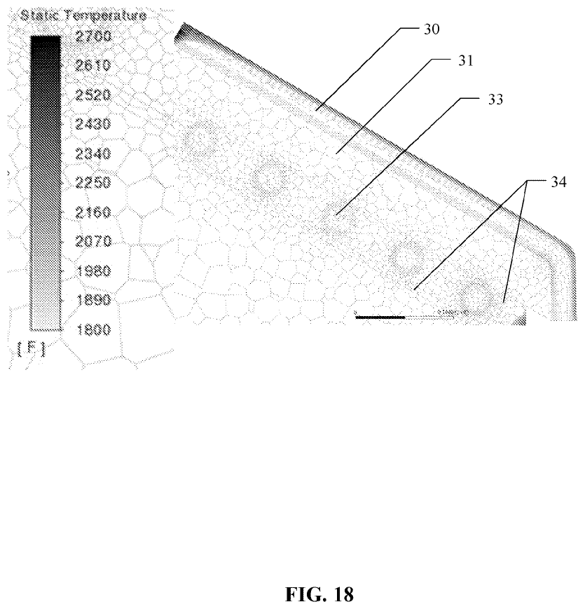

In FIG. 17 and FIG. 18 the results for an improved design (that incorporates an insulating fabric behind the main cooling circuits 33, shows that the heat removal provided by these cooling circuits can be directed towards cooling the silicon carbide insert 31, and thus a skull layer (white region of temperatures below 1800° F. in FIG. 18) is now present in the molten slag region, as was the intent of the invention detailed within. An additional benefit of this design improvement is that reduced heat removal from the process (as the refractory 32 underneath/behind the insulating fabric 34 is now not cooled as significantly by the cooling circuits 33) increases the overall gasifier efficiency compared with the unoptimized design.

### Example 4: Production and Testing of Slag to Confirm Vitrification and Non-Leaching Characteristics

The MSW pellets of Example 1 with ash content of 10.8% was analyzed to determined the elemental composition of the ash as summarized in Table 5 below. Additional CaCO₃ of 1.7% (relative to MSW feed) was added with the MSW pellets prior to being fed into the gasifier of Example 1. The CaCO₃ addition level was calculated based on Mills et al., supra, to achieve a slag optical basicity of 0.638 that has been found to achieve the optimal balance of reduced slag viscosity without being overly corrosive to the refractory lining of the gasifier and especially the slag reservoir zone 6. The impact of the CaCO₃ addition is to reduce the T250 of the slag at 2012° F. vs. the MSW ash of 2118° F. as reported in Table 5. Without wishing to be bound by theory, the CaCO₃ reduces the viscosity by disrupting the SiO₂ network.

### REPORT OF ANALYSIS

Lab Number: R9678
Sample 1D: MSW Pellets 2/20/20 1900

TABLE 5
MSW pellets ash analysis (same MSW pellets as used for Example 1)

| | Wt. % | | | |
|---|---|---|---|---|
| | Ignited Basis | Method | Date Analyzed | Analyst |
| Silicon Dioxide, % as SiO2 | 25.74 | XRF | Mar. 13, 2020 | CW |
| Aluminum Oxide, % as Al2O3 | 29.31 | XRF | Mar. 13, 2020 | CW |
| Iron Oxide, % as Fe2O3 | 5.10 | XRF | Mar. 13, 2020 | CW |
| Calcium Oxide, % as CaO | 25.69 | XRF | Mar. 13, 2020 | CW |
| Magnesium Oxide, % as MgO | 2.53 | XRF | Mar. 13, 2020 | CW |
| Sodium Oxide, % as Na2O | 4.44 | XRF | Mar. 13, 2020 | CW |
| Potassium Oxide, % as K2O | 1.46 | XRF | Mar. 13, 2020 | CW |
| Titanium Dioxide, % as TiO2 | 2.3 | XRF | Mar. 13, 2020 | CW |
| Manganese Dioxide, % as MnO2 | 0.18 | XRF | Mar. 13, 2020 | CW |
| Phosphorus Pentoxide, % as P2O5 | 1.84 | XRF | Mar. 13, 2020 | CW |
| Strontium Oxide, % as SrO | 0.03 | XRF | Mar. 13, 2020 | CW |
| Barium Oxide, % as BaO | 0.14 | XRF | Mar. 13, 2020 | CW |
| Sulfur Trioxide, % as SO3 | 1.24 | XRF | Mar. 13, 2020 | CW |
| Alkalies as Na2O | 5.40 | XRF | Mar. 13, 2020 | CW |
| Base to Acid Ratio | 0.68 | XRF | Mar. 13, 2020 | CW |
| Silica Ratio | 0.44 | XRF | Mar. 13, 2020 | CW |
| T250° F. | 2,118 | XRF | Mar. 13, 2020 | CW |

The gasifier was operated as in Example 1 and slag was collected in the slag reservoir zone 6 and held for 8 hours at a temperature of 2700° F. at which time the taphole was opened allowing slag to flow directly into a quench chamber filled with water. Without wishing to be bound by theory, it is understood that rapid quenching of slag results in a glassy structure provided the slag chemistry has been adjusted to ensure the chemical composition is within the glassy regime as described by Mills et al., supra. Without being bound by theory, a glassy structure is believed to be facilitate effective vitrification of minerals to minimize leaching.

The slag was submitted for leaching tests including the Total Threshold Limit Concentration or TTLC, the Soluble Threshold Limit Concentration or STLC (both TTLC and STLC being California requirements) as well as the US Federal EPA Toxicity Characteristic Leaching Procedure or TCLP.

Results of the tests are summarized in Table 6, and as is evident from the data, the protocols followed were effective in producing a non-leaching slag that allows it to be used for commercial applications.

TABLE 6
Results from slag leaching tests (TTLC, STLC and TCLP)

| | TTLC | | | | | STLC | | | TCLP | | |
|---|---|---|---|---|---|---|---|---|---|---|---|
| | | | Haz. | STLC | TCLP | | | Haz. | | | Haz. |
| Elements | Limit | Result | Waste | Req | Req | Limit | Result | Waste | Limit | Result | Waste |
| (Symbol) | mg/Kg | mg/Kg | Y/N | Y/N | Y/N | mg/L | mg/L | Y/N | mg/L | mg/L | Y/N |
| Antimony (Sb) | 500 | ND | N | No | — | 15 | ND | N | — | ND | N |
| Arsenic (As) | 500 | 0.76 | N | No | N | 5 | ND | N | 5 | ND | N |
| Barium (Ba) | 10,000 | 960 | N | No | N | 100 | 5 | N | 100 | 0.59 | N |
| Beryllium (Be) | 75 | 0.86 | N | No | — | 0.75 | ND | N | — | ND | N |
| Cadmium (Cd) | 100 | ND | N | No | N | 1 | ND | N | 1 | ND | N |
| Chromium (Cr) | 2,500 | 160 | N | Yes | Y | 5 | 1.1 | N | 5 | ND | N |
| Cobalt (Co) | 8,000 | 3 | N | No | — | 80 | 0.068 | N | — | ND | N |
| Copper (Cu) | 2,500 | 280 | N | Yes | — | 25 | 0.054 | N | — | 0.046 | N |
| Lead (Pb) | 1,000 | ND | N | No | N | 5 | 0.2 | N | 5 | 0.054 | N |
| Mercury (Hg) | 20 | ND | N | No | N | 0.2 | ND | N | 0.2 | ND | N |
| Molybdenum (Mo) | 3,500 | 11 | N | No | — | 350 | 0.15 | N | — | ND | N |
| Nickel (Ni) | 2,000 | 54 | N | No | — | 20 | 1.3 | N | — | 0.096 | N |
| Selenium (Se) | 100 | 0.71 | N | No | N | 1 | ND | N | 1 | ND | N |
| Silver (Ag) | 500 | 0.48 | N | No | N | 5 | ND | N | 5 | ND | N |
| Thallium (Tl) | 700 | 0.99 | N | No | — | 7 | ND | N | — | ND | N |
| Vanadium (V) | 2,400 | 12 | N | No | — | 24 | 0.081 | N | — | ND | N |
| Zinc (Zn) | 5,000 | 2 | N | No | — | 250 | ND | N | — | ND | N |

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A fixed bed, oxygen blown, slagging gasifier for gasifying a heterogeneous waste, comprising:
one or more ports within a vessel of the gasifier to provide a stream of the heterogeneous waste into the vessel;
a plurality of lances arranged around a periphery of the vessel within a level of a bed material, the plurality of lances to inject oxygen and steam gasifier reactants into the vessel;
a tar destruction zone located above the level of the bed material and within the vessel of the gasifier;
a plurality of burners arranged around the periphery of the vessel within the tar destruction zone, the plurality of burners configured to operate above stoichiometric oxygen levels;
a cooled slag collector located at a bottom of the bed material to support the bed material and equipped with at least one slag hole to allow free drainage of slag into a slag reservoir below the cooled slag collector and to allow an upward counterflow of gases; and
the slag reservoir including a headspace and a second plurality of burners positioned within the headspace, the second plurality of burners to maintain a slag temperature of an amount of slag and to consume or gasify any remaining carbon in the amount of slag prior to a slag tapping operation.

2. The gasifier of claim 1, wherein the plurality of lances are offset from a horizontal plane and from a normal line relative to an internal refractory surface of the gasifier.

3. The gasifier of claim 1, wherein the tar destruction zone has a residence time of at least 2 seconds.

4. The gasifier of claim 1, wherein a temperature within the tar destruction zone is at least 2000° F. (1093° C.).

5. The gasifier of claim 1, wherein a temperature within the tar destruction zone is greater than 2200° F. (1204° C.).

6. The gasifier of claim 1, wherein the plurality of burners are configured to operate with a ratio of molar oxygen to a stoichiometric requirement for full combustion between 0.5 to 6.0.

7. The gasifier of claim 1, wherein the plurality of burners are offset from a horizontal plane and from a normal line relative to an internal refractory surface of the gasifier.

8. The gasifier of claim 1, wherein the cooled slag collector is positioned within the vessel and includes at least one cooling feature to maintain a steel frame and a refractory component of the gasifier within their respective design temperature limits of less than 350° C. and less than 1760° C.

9. The gasifier of claim 1, wherein the cooled slag collector is positioned within the vessel and includes at least one cooling feature to maintain a steel frame and a refractory component of the gasifier within their respective design temperature limits, the at least one cooling feature comprising at least one limpet coils and at least one supplemental copper coil.

10. The gasifier of claim 1, wherein the cooled slag collector is positioned within the vessel and includes at least one cooling feature to maintain a steel frame and a refractory component of the gasifier within their respective design temperature limits, wherein heat absorbed from the gasifier forms a protective skull layer within the a slag collection hearth zone and inside a slag hole, the protective skull layer to minimize erosion and corrosion of a protective refractory and to prevent slag from freezing off.

11. The gasifier of claim 1, wherein the slag reservoir is configured to hold allow slag for an average residence time of greater than 1 hour to ensure complete conversion of residual carbon.

12. The gasifier of claim 1, wherein a slag level in the slag reservoir is controlled by a mechanical valve by restricting a size of a taphole based on a pressure differential across the taphole.

13. The gasifier of claim 1, wherein a slag level in the slag reservoir is controlled by an additional vessel that encloses a slag discharge and is pressurized with an inert gas to control a pressure differential across a taphole.

14. The gasifier of claim 1, wherein a slag level in the slag reservoir is controlled by a mechanical valve and an additional vessel, the mechanical valve to control the slag level by restricting of a taphole based on a pressure differential across the taphole, the additional vessel to enclose a slag discharge and including an inert gas, the inert gas to pressurize the additional vessel to control the pressure differential.

15. The gasifier of claim 1, wherein a syngas exiting a top of a polisher section of the gasifier has tar content less than 5 g/Nm³.

16. The gasifier of claim 1, wherein the amount of slag is non-leaching according to TCLP testing.

17. The gasifier of claim 1, wherein the heterogeneous waste requires pre-processing comprising only basic shredding to a size range of ¼ to 2″(6 mm to 50 mm).

18. The gasifier of claim 1, wherein the gasifier does not include a plasma torch.
